(19) United States
(12) Patent Application Publication
(10) Pub. No.: US 2006/0076889 A1
(43) Pub. Date: Apr. 13, 2006

(54) Plasma display panel (PDP)

(76) Inventor: Seung-Beom Seo, Suwon-si (KR)

Correspondence Address: Robert E. Bushnell, Suite 300, 1522 K Street, N.W., Washington, DC, 20005-1202, US

(21) Appl. No.: 11/207,930

(22) Filed: Aug. 22, 2005

(30) Foreign Application Priority Data
Oct. 13, 2004 (KR) 10-2004-0081750

(51) Int. Cl. H01J 17/49

(52) U.S. Cl. 313/582

(57) ABSTRACT

A Plasma Display Panel (PDP) having a structure capable of preventing a permanent afterimage generated by damage to a protective film during a sustain discharge includes: front and rear substrates arranged to face each other; barrier ribs arranged between the front and rear substrates to partition discharge cells in combination with the front and rear substrates; a plurality of electrodes adapted to generate a discharge in the discharge cells; a plurality of X electrodes each including a transparent X electrode arranged at a rear side of the front substrate in the discharge cell to extend in one direction; a plurality of Y electrodes each including a transparent Y electrode arranged at a rear side of the front substrate in the discharge cell to be spaced apart from the X electrode by a gap and to extend to and be aligned with the transparent X electrode; opaque X and Y shield layers respectively arranged on one end surface of the transparent X and Y electrodes, the one end surfaces neighboring the gap; a first dielectric layer arranged to cover a rear surface of the front substrate, the X and Y electrodes, and the opaque X and Y shield layers; a protective layer arranged to coat a rear surface of the first dielectric layer; a phosphor layer arranged in each discharge cell; and a discharge gas filling in an inner space of each discharge cell.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 13 Oct. 2004 and there duly assigned Serial No. No. 10-2004-0081750.

### BACKGROUND OF THE INVENTION

1. Field of the Invention

The present invention relates to a Plasma Display Panel (PDP), and more particularly, to a PDP in which electrodes are respectively formed on facing substrates, a discharge gas is injected into a discharge space between the facing substrates, UltraViolet (UV) light rays are radiated in the discharge space by a voltage supplied to the electrodes, and an image is produced by light emitted by the UV light rays.

2. Description of the Related Art

A PDP can be broadly classified into a Direct Current (DC) PDP and an Alternating Current (AC) PDP according to the type of discharge. In the DC PDP, corresponding electrodes are exposed to a discharge space, and a discharge is generated by a direct movement of charged particles between the corresponding electrodes. In the AC PDP, at least one electrode is covered with a dielectric layer, and a discharge is generated by an electric field induced by a wall charge, instead of by the direct movement of the charged particles.

A unit PDP panel includes an upper plate for displaying an image to users and a lower plate arranged to face the upper plate.

The upper plate includes a front substrate and sustain electrode pairs. The front substrate is made of glass, and the sustain electrode pairs are arranged on a rear surface of the front substrate. The sustain electrode pair includes an X electrode and a Y electrode. The X electrode includes a transparent X electrode and a bus X electrode formed on a partial rear surface of the transparent X electrode. The Y electrode includes a transparent Y electrode and a bus Y electrode formed on a partial rear surface of the transparent Y electrode.

The lower plate includes a rear substrate and a plurality of address electrodes. The rear substrate is arranged to face the front substrate, and the address electrodes are arranged on a front surface of the rear substrate to intersect the sustain electrode of the front substrate.

A front dielectric layer is formed on the rear surface of the front substrate to bury the sustain electrode pair, and a rear dielectric layer is formed on the front surface of the rear substrate to bury the address electrodes. A protective film is formed on the front dielectric layer, and barrier ribs are formed on the rear dielectric layer to main a discharge distance, to partition discharge cells and to prevent an electro-optical crosstalk between the discharge cells.

Red, Green, and Blue (RGB) phosphors are coated on both side surfaces of the barrier ribs and a front surface of the rear dielectric layer on which the barrier ribs are not formed.

When a sustain discharge is generated between the X electrode and the Y electrode in the PDP, a discharge amount at the right portion (that is, a portion near the Y electrode) of the X electrode becomes larger than that of the left portion thereof, and a discharge amount at the left portion (that is, a portion near the X electrode) of the Y electrode becomes larger than that of the right portion thereof.

That is, a sustain discharge amount at a gap portion between the facing portions of the electrodes is relatively large. However, the sustain discharge amount at the gap portion becomes too large when the sustain discharge is sustained. Accordingly, a portion of the protective film corresponding to the gap portion is damaged more greatly than the other portions thereof.

However, since the transparent X electrode and the transparent Y electrode are arranged on the front substrate corresponding to a center portion of a discharge cell so as to increase luminance, the greatly-damaged portion of the protective film 19 is undesirably observed by the naked eye through the transparent electrodes.

The protective film protects the front dielectric layer from ion sputtering and lowers a sustain voltage and a driving voltage due to its high Secondary Electron Emission (SEE) coefficient. However, radiation efficiency greatly decreases especially at the greatly-damaged portion of the protective film, whereby a permanent afterimage (image sticking) is undesirably generated on the PDP.

In addition, visible light rays generated by the RGB phosphors have different luminance ratios. Accordingly, an optimum color temperature cannot be obtained when sustain discharge frequencies for the RGB phosphors in each discharge cell coated with RGB phosphors are the same.

A method that changes the thickness of the front or rear dielectric layer or an interval therebetween can be used to make the sustain discharge frequencies for the RGB phosphors different. However, such a method has a limitation in changing the thickness of the front or rear dielectric layer or the interval therebetween. Furthermore, the effect of such a structural modification becomes more reduced with a recent trend toward the size and thickness reduction of a PDP.

### SUMMARY OF THE INVENTION

The present invention provides a Plasma Display Panel (PDP) having a structure capable of preventing a permanent afterimage generated by damage to a protective film during a sustain discharge.

The present invention also provides a PDP having a structure capable of adjusting a color temperature in each discharge cell equipped with phosphor layers generating visible light rays of different colors.

According to one aspect of the present invention, a PDP is provided comprising: front and rear substrates arranged to face each other; barrier ribs arranged between the front and rear substrates to partition discharge cells in combination with the front and rear substrates; a plurality of electrodes adapted to generate a discharge in the discharge cells; a plurality of X electrodes each including a transparent X electrode arranged at a rear side of the front substrate in the discharge cell to extend in one direction; a plurality of Y electrodes each including a transparent Y electrode arranged at a rear side of the front substrate in the discharge cell to be spaced apart from the X electrode by a gap and to extend to and be aligned with the transparent X electrode; opaque X and Y shield layers respectively arranged on one end surface of the transparent X and Y electrodes, the one end surfaces neighboring the gap; a first dielectric layer arranged to cover a rear surface of the front substrate, the X and Y electrodes, and the opaque X and Y shield layers; a protective layer arranged to coat a rear surface of the first dielectric layer; a phosphor layer arranged in each discharge cell; and a discharge gas filling in an inner space of each discharge cell.

The X electrode preferably includes a bus X electrode arranged on a rear end surface of the transparent X electrode and adapted to reduce line resistance of the transparent X electrode, and the Y electrode preferably includes a bus Y electrode arranged on a rear end surface of the transparent Y electrode and adapted to reduce line resistance of the transparent Y electrode.

The opaque X and Y shield layers are preferably electrically conductive.

The X and Y shield layers are preferably respectively of the same materials as those of the X and Y electrodes.

The opaque X shield layer is preferably electrically conductive and is arranged on one end surface of the transparent X electrode neighboring the gap, and the opaque Y shield layer is preferably electrically conductive and is arranged on one end surface of the transparent Y electrode neighboring the gap.

Each discharge cell is preferably one of RGB discharge cells having one of RGB phosphor layers adapted to generate one of the RGB visible light rays, and widths of X and Y shield layers disposed in the RGB discharge cells are preferably varied according to color types of the discharge cells.

Widths of X and Y shield layers arranged in the R discharge cells are preferably greater than widths of X and Y shield layers arranged in the G discharge cells and widths of X and Y shield layers arranged in the G discharge cells are preferably greater than widths of X and Y shield layers arranged in the B discharge cells.

Widths of X and Y shield layers arranged in the B discharge cells are preferably less than 50 μm, and widths of X and Y shield layers arranged in the R discharge cells are preferably less than 120 μm.

The PDP preferably further comprises: an address electrode arranged on a front surface of the rear substrate; and a second dielectric layer arranged on a front side of the rear substrate to cover the rear substrate and the address electrode.

According to another aspect of the present invention, a PDP is provided comprising: front and rear substrates arranged to face each other; barrier ribs arranged between the front and rear substrates and partitioning discharges cells in combination with the front and rear substrates; a plurality of electrodes adapted to generate a discharge in the discharge cells; a plurality of X electrodes each including a transparent X electrode arranged on a rear side of the front substrate in the discharge cell to extend in one direction; a plurality of Y electrodes each including a transparent Y electrode arranged on a rear side of the front substrate in the discharge cell to be spaced apart from the X electrode by a gap and to extend and be aligned with the transparent X electrode; opaque X and Y shield layers respectively arranged on one end surface of the transparent X and Y electrodes, the one end surfaces neighboring the gap; a first dielectric layer arranged to cover a rear surface of the front substrate, the X and Y electrodes, and the opaque X and Y shield layers; RGB phosphor layers adapted to respectively generate one of RGB visible light rays in each discharge cell; and a discharge gas filling in an inner space of each discharge cell; wherein widths of X and Y shield layers arranged in RGB discharge cells are varied according to required color types of the discharge cells.

Widths of X and Y shield layers arranged in the R discharge cells are preferably greater than widths of X and Y shield layers arranged in the G discharge cells and widths of X and Y shield layers arranged in the G discharge cells are preferably greater than widths of X and Y shield layers arranged in the B discharge cells.

The widths of X and Y shield layers arranged in the B discharge cells are preferably less than 50 μm, and the widths of X and Y shield layers arranged in the R discharge cells are preferably less than 120 μm.

The opaque X and Y shield layers are preferably electrically conductive.

The X electrode preferably includes a bus X electrode arranged on a rear end surface of the transparent X electrode and adapted to reduce line resistance of the transparent X electrode, and the Y electrode preferably includes a bus Y electrode arranged on a rear end surface of the transparent Y electrode and adapted to reduce line resistance of the transparent Y electrode.

The X and Y shield layers are preferably respectively of the same materials as those of the bus X and Y electrodes.

The PDP preferably further comprises: an address electrode arranged on a front surface of the rear substrate; and a second dielectric layer arranged on a front side of the rear substrate to cover the rear substrate and the address electrode.

A protective layer is preferably arranged to coat a rear surface of the first dielectric layer.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a sectional view of a unit discharge cell of a PDP;

FIG. 2 is an exploded perspective view of a PDP according to an embodiment of the present invention;

FIG. 3 is a cross-sectional view of a side of the PDP taken along line III-III of FIG. 2;

FIG. 4 is a sectional view of a blue discharge cell of FIG. 2;

FIG. 5 is a sectional view of a green discharge cell of FIG. 2;

FIG. 6 is a sectional view of a red discharge cell of FIG. 2; and

FIG. 7 is a rear plan view of a sustain discharge cell and X and Y light shielding layers of FIG. 2.

### DETAILED DESCRIPTION OF THE INVENTION

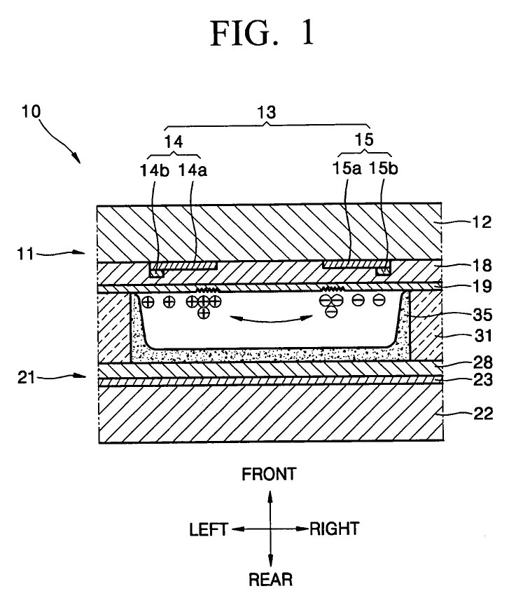

FIG. 1 is a sectional view of a unit discharge cell (pixel) of a PDP. Referring to FIG. 1, a unit PDP panel 10 includes an upper plate 11 for displaying an image to users and a lower plate 21 arranged to face the upper plate 11.

The upper plate 11 includes a front substrate 12 and sustain electrode pairs 13. The front substrate 12 is made of glass, and the sustain electrode pairs 13 are arranged on a rear surface of the front substrate 12. The sustain electrode pair 13 includes an X electrode 14 and a Y electrode 15. The X electrode 14 includes a transparent X electrode 14a and a bus X electrode 14b formed on a partial rear surface of the transparent X electrode 14a. The Y electrode 15 includes a transparent Y electrode 15a and a bus Y electrode 15b formed on a partial rear surface of the transparent Y electrode 15a.

The lower plate 21 includes a rear substrate 22 and a plurality of address electrodes 23. The rear substrate 22 is arranged to face the front substrate 12, and the address electrodes 23 are arranged on a front surface of the rear substrate 22 to intersect the sustain electrode 13 of the front substrate 12.

A front dielectric layer 18 is formed on the rear surface of the front substrate 12 to bury the sustain electrode pair 13, and a rear dielectric layer 28 is formed on the front surface of the rear substrate 22 to bury the address electrodes 23. A protective film 19 made of MgO (magnesium oxide) is formed on the front dielectric layer 18, and barrier ribs 31 are formed on the rear dielectric layer 28 to main a discharge distance, to partition discharge cells and to prevent an electro-optical crosstalk between the discharge cells.

Red, Green, and Blue (RGB) phosphors 35 are coated on both side surfaces of the barrier ribs 31 and a front surface of the rear dielectric layer 28 on which the barrier ribs 31 are not formed.

When a sustain discharge is generated between the X electrode 14 and the Y electrode 15 in the PDP 10, a discharge amount at the right portion (that is, a portion near the Y electrode 15) of the X electrode 14 becomes larger than that of the left portion thereof, and a discharge amount at the left portion (that is, a portion near the X electrode 14) of the Y electrode 15 becomes larger than that of the right portion thereof.

That is, a sustain discharge amount at a gap portion between the facing portions of the electrodes 14 and 15 is relatively large. However, the sustain discharge amount at the gap portion becomes too large when the sustain discharge is sustained. Accordingly, a portion of the protective film 19 corresponding to the gap portion is damaged more greatly than the other portions thereof.

However, since the transparent X electrode 14a and the transparent Y electrode 15a generally made of Indium Tin Oxide (ITO) are arranged on the front substrate 12 corresponding to a center portion of a discharge cell so as to increase luminance, the greatly-damaged portion of the protective film 19 is undesirably observed by the naked eye through the transparent electrodes 14a and 15a.

The protective film 19 protects the front dielectric layer 18 from ion sputtering and lowers a sustain voltage and a driving voltage due to its high Secondary Electron Emission (SEE) coefficient. However, radiation efficiency greatly decreases especially at the greatly-damaged portion of the protective film 19, whereby a permanent afterimage (image sticking) is undesirably generated on the PDP 10.

In addition, visible light rays generated by the RGB phosphors 35 have different luminance ratios. Accordingly, an optimum color temperature cannot be obtained when sustain discharge frequencies for the RGB phosphors in each discharge cell coated with RGB phosphors are the same.

A method that changes the thickness of the front or rear dielectric layer (18 or 28) or an interval therebetween can be used to make the sustain discharge frequencies for the RGB phosphors different. However, such a method has a limitation in changing the thickness of the front or rear dielectric layer or the interval therebetween. Furthermore, the effect of such a structural modification becomes more reduced with a recent trend toward the size and thickness reduction of a PDP.

The present invention is described more fully below with reference to the accompanying drawings, in which exemplary embodiments of the present invention are shown.

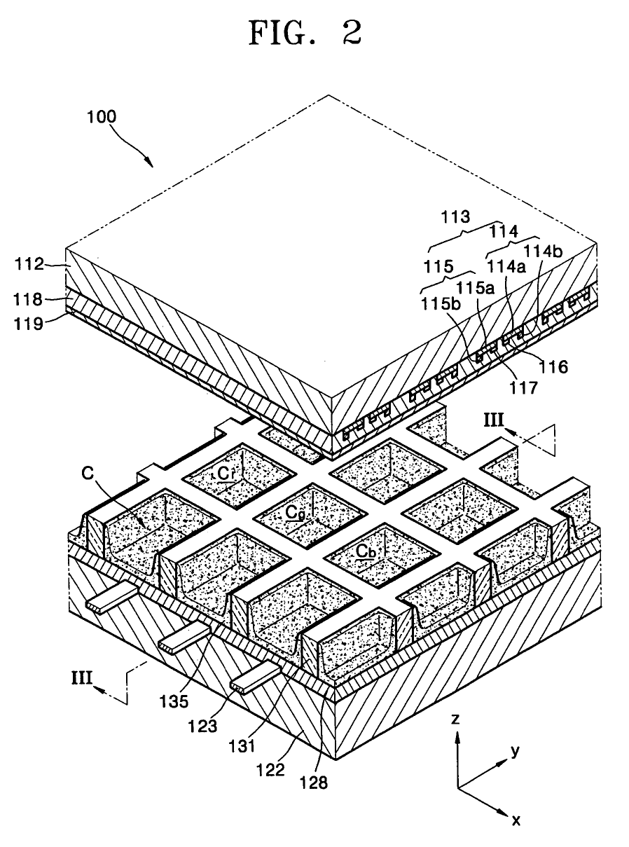

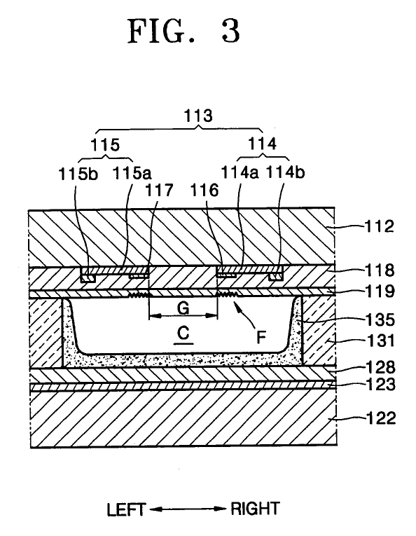

FIG. 2 is an exploded perspective view of a PDP according to an embodiment of the present invention, and FIG. 3 is a cross-sectional view of a side of the PDP taken along line III-III of FIG. 2.

Referring to FIGS. 2 and 3, a PDP 100 includes a front substrate 112, a rear substrate 122, sustain electrode pairs 113, a first dielectric layer 118, a phosphor layer 135, address electrodes 123, a barrier rib 131, and discharge gas (not shown).

The front substrate 112 is transparent and is arranged parallel to the rear substrate 122 at a front side (z direction) of the rear substrate 122 so that visible rays in a discharge cell can passes therethrough and an image can be projected. The front substrate 112 is made of a material having good light permeability, such as glass, whereby visible light rays are emitted therethrough. The rear substrate 122 can also be made of material having glass as a main constituent.

The sustain electrode pair 113 is formed of an X electrode 114 and a Y electrode 115, and the plural sustain electrode pairs 113 are formed at a rear side (−z direction) of the front substrate 112.

The address electrodes 123 can be arranged at a front side of the rear substrate 122, which faces a surface of the front substrate 112 on which the sustain electrode pairs 113. The address electrodes 123 generate an address discharge in combination with the Y electrodes 115.

The sustain electrode pairs 113 can be extended across a sub-pixel, that is, in a y-direction in FIG. 2, and the address electrodes 123 can be extended across the sub-pixel in another direction intersecting the sustain electrode pairs 113, that is, along a x-direction in FIG. 2.

The X electrode 114 is formed of a transparent X electrode 114a and a bus X electrode 114b, and the Y electrode 115 is formed of a transparent Y electrode 115a and a bus Y electrode 115b. The transparent X electrode 114a and the transparent Y electrode 115a are made of ITO. The bus X electrode 114b and the bus Y electrode 115b are made of a metallic material, for example, and are respectively formed on the rear surfaces of the transparent X and Y electrodes 114a and 115a to reduce the electrode line resistance of the transparent X and Y electrodes 114a and 115a. However, the present invention is not limited to this construction. For example, the X electrode 114 and the Y electrode can be respectively formed of only the transparent X electrode 114a and the transparent Y electrode 115a.

The first dielectric layer 118 is arranged at a rear side of the front substrate having the sustain electrode pairs 113 to bury the X electrode 114, the Y electrode 115 and the front substrate 112. Also, the address electrodes 123 and the rear substrate 122 are preferably covered by the second dielectric layer 128.

The first and second dielectric layers 118 and 128 are formed of a dielectric material that can not only induce an electric charge but also prevent the sustain electrode pairs 113 and the address electrodes 123 from being damaged by the collision of positive ions and electrons thereagainst during discharge.

A protective film 119 is preferably formed on a rear surface of the first dielectric layer 118. The protective film 119, formed of an MgO film through evaporation, for example, prevents the damage of the protective film caused by the sputtering of plasma particles, and lowers a discharge voltage and a sustain voltage through the emission of secondary electrons.

The barrier ribs 131 are formed between the front and substrates 112 and 122, partition a discharge cell “C” in combination with the front and rear substrates, and prevent erroneous discharge between the discharge cells.

An inside of the discharge cell “C” is coated with the phosphor layer 135. The UV light rays generated by the sustain discharge impinge upon the phosphor layer 135 to thereby excite visible light rays and emit the visible light rays outside.

The discharge gas contained within the discharge cell “C” is formed of a penning mixture, such as Xe—Ne, Xe—He, Xe—Ne—He or so on. Xe is used as main discharge gas because Xe is not dissociated by a discharge because it is a chemically stable inert gas, and because Xe has a low excitation voltage and a long emission wavelength because it has a high atomic number. He or Ne is used as a buffer gas because it can reduce a voltage decrease effect due to a panning effect by Xe and a sputtering effect in a high pressure state. An inert gas, such as Kr, can also be used as the main gas.

In the PDP 100, when a given voltage is supplied to the address electrode 123 and the Y electrode 115, a discharge cell for radiation is selected, an address discharge is generated between the two electrodes 115 and 123, and then a wall charge is charged on the first dielectric layer 118. Thereafter, when a given voltage is alternately supplied to the X electrode 114 and the Y electrode 115, the wall charge is moved between the two electrodes 114 and the 115, thereby causing the discharge gas to generate a sustain discharge. Accordingly, the discharge gas generates UV light rays, and the UV light rays excite the phosphor of the phosphor layer 135, thereby forming an image.

In more detail, when a discharge initiating voltage of 150V to 300V is supplied to the sustain electrode pair 113 and the address electrode 115, a wall charge is formed on an inner surface of a corresponding discharge cell.

Thereafter, when an address discharge voltage is supplied to the Y electrode 115 and the corresponding address electrode 123 in the selected discharge cell, an address discharge is generated between the two electrodes 115 and 123. Thereafter, when a sustain discharge voltage of 150V or more is alternately supplied to the corresponding Y and X electrodes 115 and 114, a sustain discharge is generated, whereby the radiation of a corresponding discharge cell is sustained during a given time. That is, an electric field is generated in the discharge cell, and a very small amount of electrons of discharge gas is accelerated. The accelerated electrons collide with neutral particles of the discharge gas, thereby causing the neutral particles to be ionized into electrons and ions. The neutral particles are more rapidly ionized into electrons and ions by another collision of the ionized electrons and neutral particles, whereby the discharge gas changes to a plasma state and simultaneously vacuum UV light rays are generated.

The generated UV light rays excite the phosphor of the phosphor layer 135 to thereby generate visible light rays, and the generated visible light rays are projected externally through the front substrate 112, whereby the radiation of the discharge cell, that is, an image display can be perceived.

However, a sustain discharge is strongly generated at a gap portion “G” between the transparent X and Y electrodes 114a and 115a, whereby the failure “F” of the protective film 119 is generated at a center portion of the discharge cell. Consequently, the radiation efficiency of the center portion of the discharge cell is reduced, whereby a permanent afterimage can be generated at the center portion of the discharge cell.

Accordingly, in the present invention, an X shield layer 116 is arranged on a left end portion of the transparent X electrode 114a (that is, an end portion thereof positioned near the gap portion “G”), and a Y shield layer 117 is arranged on a right end portion of the transparent Y electrode 115a (that is, an end portion thereof positioned near the gap portion “G”). The X and Y shield layers 116 and 117 are formed of an opaque material, whereby the failure “F” of the protective film 119 is prevented from being observed externally. Consequently, the X and Y shield layers 116 and 117 prevent the permanent afterimage that can be generated at the center portion of the discharge cell.

The X and Y shield layers 116 and 117 are preferably made of conductive a material because they are respectively formed on the transparent X and Y electrodes 114a and 115a. That is, when the X and Y shield layers 116 and 117 are made of a non-conductive material, a sustain discharge between the transparent X and Y electrodes 114a and 115a is obstructed and thus insufficiently generated. The insufficient sustain discharge can be compensated for by a high sustain voltage, but such a high sustain voltage reduces the efficiency of the PDP.

The X electrode 114 can include the bus X electrode 114b arranged on a rear right end surface of the transparent X electrode 114a, and the Y electrode 115 can include the bus Y electrode 115b arranged on a rear left end surface of the transparent Y electrode 115a. The X shield layer 116 is preferably formed on a rear left end surface of the transparent X electrode 114a, and the Y shield layer 117 is preferably formed on a rear left end surface of the transparent Y electrode 115a.

The X and Y shield layers 116 and 117 are preferably made of the same material as that of the bus X and Y electrodes 114b and 115b, whereby the X and Y shield layers 116 and 117 can be formed at the same time that the bus X and Y electrodes 114b and 115b are formed. That is, if the bus X and Y electrodes 114b and 115b are preferably made of a conductive material so as to compensate for the line resistance of the transparent X and Y electrodes 114a and 115a, such a conductive material is preferably used as the material of the X and Y shield layers 116 and 117. Also, if the bus X and Y electrodes 114b and 115b are respectively formed on the X and Y electrodes 114 and 115 using a mask, the X and Y shield layer 116 and 117 can be easily respectively formed on the X and Y electrodes 114 and 115 by forming openings for not only the bus X and Y electrodes but also for the X and Y shield layers on the mask, disposing the resulting mask between the front substrate 112 and a spray nozzle and then spraying the material of the bus X and Y electrodes on the disposed mask.

Unlike this structure, the X electrode 114 can not be equipped with the bus X electrode 114b, and the conductive X shield layer 116, instead of the bus X electrode 114b, can be connected to an X electrode driving unit. Also, the Y electrode 115 can not be equipped with the bus Y electrode 115b, and the conductive Y shield layer 116, instead of the bus Y electrode 115b, can be connected to a Y electrode driving unit.

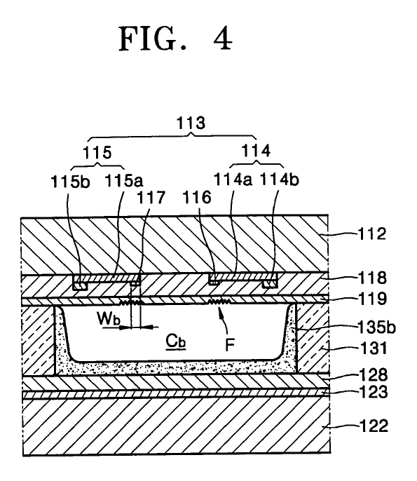

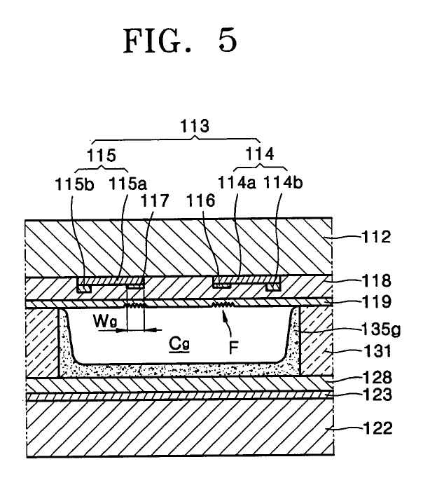

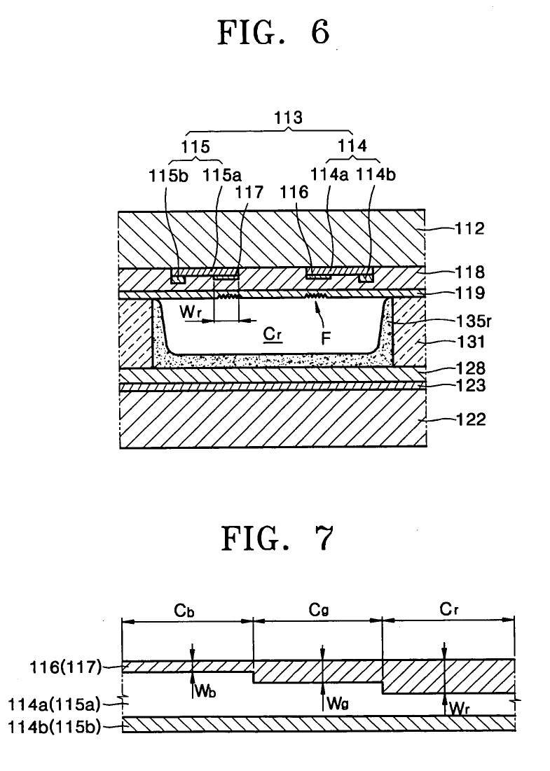

FIG. 4 is a sectional view of a blue discharge cell of FIG. 2, FIG. 5 is a sectional view of a green discharge cell of FIG. 2, FIG. 6 is a sectional view of a red discharge cell of FIG. 2, and FIG. 7 is a rear plan view of a sustain discharge cell and X and Y light shielding layers of FIG. 2.

As shown in FIGS. 4 through 6, the phosphor layer 135 can be classified into a Red (R) phosphor layer 135r, a Green (G) phosphor layer 135g and a Blue (B) phosphor layer 135b. The R phosphor layer 135r can include a phosphor such as Y(V,P)O₄:Eu, the G phosphor layer 135g can include phosphors such as Zn₂SiO₄:Mn, YBO₃:Tb, and the B phosphor layer 135b can include a phosphor such as BAM:Eu.

An R discharge cell Cr including the R phosphor layer 135r, a G discharge cell Cg including the G phosphor layer 135g, and a B discharge cell Cb including the B phosphor layer 135b respectively function as an R sub-pixel, a G sub-pixel and a B sub-pixel. The R, G and B sub-pixels together constitute a unit pixel to produce colors according to combinations of the three primary colors.

In more detail, when the luminance of R, G and B light from the R, G and B phosphor layers 135r, 135g and 135b each is subdivided into many levels (for example, 256 levels) and the subdivided R, G and B light are mixed in many combinations, 16.77-million colors can be produce from the unit pixel. For example, when the R, G and B lights each has 256 gradations, a black color is displayed if the R, G and B gradations are all “0”, and a white color is displayed if the R, G and B gradations are all “1”. Also, when the R, G and B gradations are below 256 but are identical to one another, a low-luminance white color (that is, a gray color) is displayed.

When a white color temperature is formed by three primary colors, it is generally estimated that a white color temperature of 9000K through 10000K (Kelvin) is suitable for Asia. It is preferable that an optimal color temperature is set according respective conditions.

In general, a color temperature of an object is defined as a temperature of a black-body that radiates light of a color identical to that of light radiated by the object.

Accordingly, when the luminance of each discharge cell is changed, a white color temperature is accordingly changed. In the present invention, widths of the X and Y shield layers 116 and 117 are varied according to the R, G and B discharge cells Cr, Cg and Cb so as to adjust an optical color temperature while making sustain discharge frequencies of the cells Cr, Cg and Cb identical.

This is because the amount of light emitted from the discharge cell C to the outside is decreased due to the X and Y shield layer 116 and 117 formed therein, thereby reducing the luminance of the discharge cell C.

Accordingly, the luminance of the discharge cell C is varied according to the widths of the X and Y shield layers 116 and 117, whereby the color temperature can be easily adjusted.

A conventional white color temperature is about 6500K. Accordingly, in order to embody an white color temperature of 9000K suitable for Asia, it is necessary to raise the luminance of the B discharge cell Cb the most and to lower the luminance of the R discharge cell Cr the most.

Accordingly, as shown in FIGS. 4 through 7, the X and Y shield layers 116 and 117 are preferably formed such that the width “Wr” of X and Y shield layers arranged in the cell Cr is greater than the width “Wg” of X and Y shield layers arranged in the cell Cg greater than the width “Wb” of X and Y shield layers arranged in the cell Cb.

When the width of the X and Y shield layers 116 and 117 are excessively increased, the luminance is undesirably reduced. Accordingly, it is preferable that the width “Wb” is below 50 μm and the width “Wr” is below 120 μm.

As stated above, the inventive X and Y shield layers 116 and 117 prevents the permanent afterimage by making the failure of the protective film be invisible to the naked eye, thereby improving an image quality of the PDP.

Also, the luminance in the discharge cell is adjusted by varying the width of the X and Y shield layers, whereby the white color temperature can be easily adjusted without adjusting the sustain discharge frequency.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
front and rear substrates arranged to face each other;
barrier ribs arranged between the front and rear substrates to partition discharge cells in combination with the front and rear substrates;
a plurality of electrodes adapted to generate a discharge in the discharge cells;
a plurality of X electrodes each including a transparent X electrode arranged at a rear side of the front substrate in the discharge cell to extend in one direction;
a plurality of Y electrodes each including a transparent Y electrode arranged at a rear side of the front substrate in the discharge cell to be spaced apart from the X electrode by a gap and to extend to and be aligned with the transparent X electrode;
opaque X and Y shield layers respectively arranged on one end surface of the transparent X and Y electrodes, the one end surfaces neighboring the gap;
a first dielectric layer arranged to cover a rear surface of the front substrate, the X and Y electrodes, and the opaque X and Y shield layers;
a protective layer arranged to coat a rear surface of the first dielectric layer;
a phosphor layer arranged in each discharge cell; and
a discharge gas filling in an inner space of each discharge cell.

2. The PDP of claim 1, wherein the X electrode includes a bus X electrode arranged on a rear end surface of the transparent X electrode and adapted to reduce line resistance of the transparent X electrode, and wherein the Y electrode includes a bus Y electrode arranged on a rear end surface of the transparent Y electrode and adapted to reduce line resistance of the transparent Y electrode.

3. The PDP of claim 2, wherein the opaque X and Y shield layers are electrically conductive.

4. The PDP of claim 1, wherein the X and Y shield layers are respectively of the same materials as those of the X and Y electrodes.

5. The PDP of claim 1, wherein the opaque X shield layer is electrically conductive and is arranged on one end surface of the transparent X electrode neighboring the gap, and wherein the opaque Y shield layer is electrically conductive and is arranged on one end surface of the transparent Y electrode neighboring the gap.

6. The PDP of claim 1, wherein each discharge cell is one of RGB discharge cells having one of RGB phosphor layers adapted to generate one of the RGB visible light rays, and wherein widths of X and Y shield layers disposed in the RGB discharge cells are varied according to color types of the discharge cells.

7. The PDP of claim 6, wherein widths of X and Y shield layers arranged in the R discharge cells are greater than widths of X and Y shield layers arranged in the G discharge cells and wherein widths of X and Y shield layers arranged in the G discharge cells are greater than widths of X and Y shield layers arranged in the B discharge cells.

8. The PDP of claim 7, wherein widths of X and Y shield layers arranged in the B discharge cells are less than 50 μm, and widths of X and Y shield layers arranged in the R discharge cells are less than 120 μm.

9. The PDP of claim 1, further comprising:
an address electrode arranged on a front surface of the rear substrate; and
a second dielectric layer arranged on a front side of the rear substrate to cover the rear substrate and the address electrode.

10. A Plasma Display Panel (PDP), comprising:
front and rear substrates arranged to face each other;
barrier ribs arranged between the front and rear substrates and partitioning discharges cells in combination with the front and rear substrates;
a plurality of electrodes adapted to generate a discharge in the discharge cells;
a plurality of X electrodes each including a transparent X electrode arranged on a rear side of the front substrate in the discharge cell to extend in one direction;
a plurality of Y electrodes each including a transparent Y electrode arranged on a rear side of the front substrate in the discharge cell to be spaced apart from the X electrode by a gap and to extend and be aligned with the transparent X electrode;
opaque X and Y shield layers respectively arranged on one end surface of the transparent X and Y electrodes, the one end surfaces neighboring the gap;
a first dielectric layer arranged to cover a rear surface of the front substrate, the X and Y electrodes, and the opaque X and Y shield layers;
RGB phosphor layers adapted to respectively generate one of RGB visible light rays in each discharge cell; and
a discharge gas filling in an inner space of each discharge cell;
wherein widths of X and Y shield layers arranged in RGB discharge cells are varied according to required color types of the discharge cells.

11. The PDP of claim 10, wherein widths of X and Y shield layers arranged in the R discharge cells are greater than widths of X and Y shield layers arranged in the G discharge cells and widths of X and Y shield layers arranged in the G discharge cells are greater than widths of X and Y shield layers arranged in the B discharge cells.

12. The PDP of claim 11, wherein the widths of X and Y shield layers arranged in the B discharge cells are less than 50 μm, and the widths of X and Y shield layers arranged in the R discharge cells are less than 120 μm.

13. The PDP of claim 11, wherein the opaque X and Y shield layers are electrically conductive.

14. The PDP of claim 13, wherein the X electrode includes a bus X electrode arranged on a rear end surface of the transparent X electrode and adapted to reduce line resistance of the transparent X electrode, and the Y electrode includes a bus Y electrode arranged on a rear end surface of the transparent Y electrode and adapted to reduce line resistance of the transparent Y electrode.

15. The PDP of claim 14, wherein the X and Y shield layers are respectively of the same materials as those of the bus X and Y electrodes.

16. The PDP of claim 10, further comprising:
an address electrode arranged on a front surface of the rear substrate; and
a second dielectric layer arranged on a front side of the rear substrate to cover the rear substrate and the address electrode.

17. The PDP of claim 10, wherein a protective layer is arranged to coat a rear surface of the first dielectric layer.
